(19) United States
(12) Patent Application Publication
(10) Pub. No.: US 2005/0286150 A1
(43) Pub. Date: Dec. 29, 2005

(54) System and method for generating disk failure warning using read back signal

(75) Inventors: Peter Michael Baumgart, San Jose, CA (US); Qing Dai, San Jose, CA (US); Charles Raymond Davis, San Jose, CA (US); Bernard E. Knigge, San Jose, CA (US)

Correspondence Address: John L. Rogitz;Rogitz & Associates, Suite 3120, 750 B Street, San Diego, CA, 92101, US

(73) Assignee: Hitachi Global Storage Technologies Netherlands B.V., Amsterdam (NL)

(21) Appl. No.: 10/878,933

(22) Filed: Jun. 28, 2004

(51) Int. Cl. G11B 27/36; G11B 21/20

(52) U.S. Cl. 360/31; 360/75

(57) ABSTRACT

The read-back signal from a HDD head is demodulated to find the pitch frequency of the head, which can be compared to a baseline value to determine if it has increased, indicating a possible failure due to contamination or lubricants pick up. Or, the pitch frequency can be used during manufacturing of a burnished pad head to determine when burnishing has been completed.

### FIELD OF THE INVENTION

The present invention relates generally to hard disk drives.

### BACKGROUND OF THE INVENTION

In a hard disk drive, lubricants and contaminants can accumulate at the head/disk interface (HDI) after long periods of operation. The lubricants, for instance, are moved around due to disk micro-waviness to form moguls and ripples. More specifically, lube moguls are caused by disk micro-waviness whereas lube ripples are induced by the so-called slider “pitch 2” frequency, discussed further below. Essentially, slider “pitch 2” frequency refers to the natural up and down oscillation of the slider toward and away from the disk. In both cases increased slider flying height modulation leads to increased lube transfer from the slider to the disk.

In any case, lube pick up and contamination accumulation between the disk and slider changes the dynamics of the HDI by changing the flying height of the slider above the disk, potentially leading to contact between the heads and disk and, hence, a potential HDD failure.

Currently, no real-time monitoring of the changed dynamics is implemented because prior to this invention a feasible solution did not exist. For instance, to attempt to monitor, in real time, the changed dynamics discussed above by using changes in the amplitude of the readback signal that is generated by the read head, a single frequency test pattern must first be written to the disk and then read back. Furthermore, the amplitude of the signal that is read back does not indicate whether the slider/disk gap interface is filled with lube/debris or with air; in either case, the amplitude of the average read-back signal remains unchanged. Hence, read-back signal amplitude by itself is insufficient to predict and/or detect lube accumulation or contamination pickup. Nevertheless, the present invention recognizes that real-time monitoring of changes that can indicate an impending failure is desirable, to alert the user to take corrective action before a failure occurs.

### SUMMARY OF THE INVENTION

Having made the following critical observation, the invention disclosed herein is provided. Specifically, the invention recognizes that impending failure from a head crash due to lowered flying height caused by lubricant pickup and/or contamination can be ascertained from a change in the frequency of the oscillation of the head in the pitch dimension, and that pitch frequency in turn can be derived from the read-back signal of the head itself to yield an indication of impending failure.

Thus, in one implementation a controller in a hard disk drive (HDD) executes logic that includes receiving a readback signal from at least one head in the HDD, and deriving, from the readback signal, a signal that represents a pitch frequency of the head. The logic also includes using the signal to determine whether to generate a warning of a failure mode. In an alternate application the logic also includes using the signal to determine whether to indicate completion of pad burnishing in a HDD design that would require it.

In a non-limiting embodiment the readback signal is demodulated to determine the pitch frequency. The pitch frequency can be the Pitch-2 mode frequency. The warning may be generated by sending a signal to a host computer that the HDD may experience a failure.

In non-limiting implementations the pitch frequency can be compared to a threshold frequency to determine whether to generate a warning of a failure mode. Or, changes in the pitch frequency can be inferred from changes in amplitudes of sidebands of the read-back signal. Also, plural measured pitch frequencies may be compared to a threshold frequency prior to determining whether to generate a warning of a failure mode.

In another aspect, a hard disk drive (HDD) executes a method which includes determining a slider pitch frequency using a read-back signal from a head associated with the slider, and then, based at least in part on the pitch frequency, indicating at least one of: whether a disk failure is imminent, and whether a pad has been sufficiently burnished during manufacture.

In yet another aspect, a chip for a hard disk drive (HDD) includes means for receiving a read-back signal from a head of the HDD, and means for deriving a pitch frequency from the read-back signal. The chip also includes means for comparing the pitch frequency to a value to determine whether to indicate a possible failure is impending, and/or to determine whether to indicate that a pad has been sufficiently burnished.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a perspective view of an exemplary embodiment of the present storage device, configured as a hard disk drive, with portions of the housing broken away;

FIG. 2 is schematic plan view of a slider showing air bearing vibration modes, both pitch (P1 and P2) and roll;

FIG. 3 is a flow chart of the present logic for determining whether the risk of a disk failure has risen;

FIG. 4 is a graph showing the pitch frequency in the read-back signal at 240 KHz; and

FIG. 5 is a flow chart of the present logic for determining when a burnish pad has been adequately burnished.

### DETAILED DESCRIPTION OF THE PREFERRED EMBODIMENT

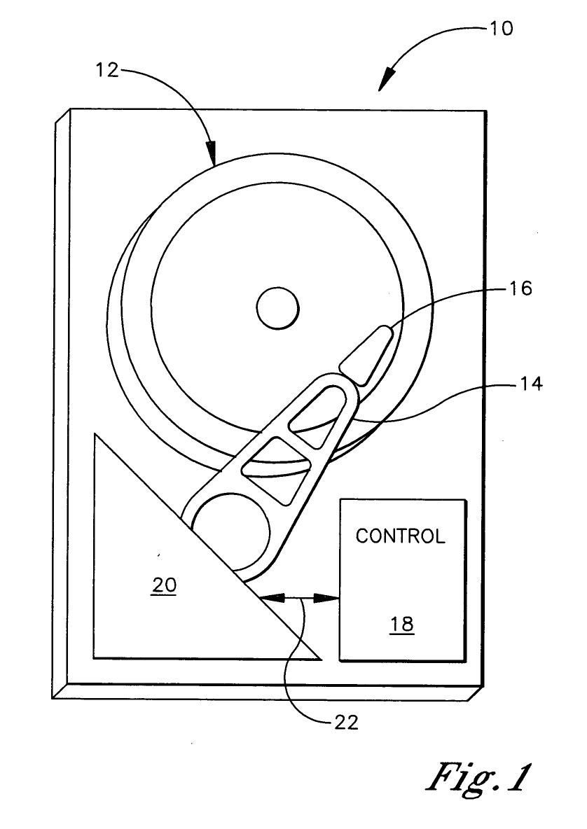

Referring initially to FIG. 1, a device is shown, generally designated 10, for storing data on a storage medium 12 that in one embodiment may be implemented by plural storage disks in a hard disk drive (HDD). When implemented as a hard disk drive, the device 10 includes an arm 14 having a read/write head 16 (part of what is colloquially referred to as a “slider”) on the end thereof in accordance with hard disk drive principles. The data storage region 12 may be managed by a controller 18 that can be a conventional hard disk drive controller modified per the logic below. The controller 18 controls an electro-mechanical actuator 20 by sending signals over a path 22 in accordance with principles known in the art to read data from and to write data to the disks 12.

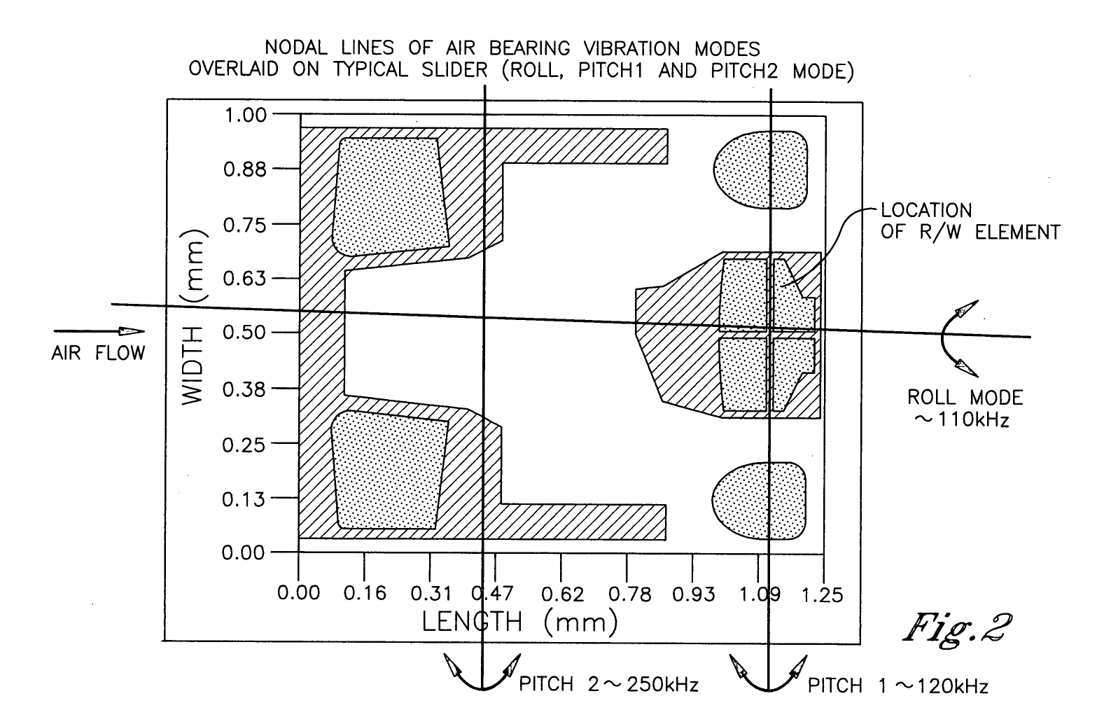

Referring briefly to FIG. 2, the “pitch” of the head 16 refers to its up-and-down motion toward and away from the disk; thus, the pitch frequency is the frequency of the vertical bouncing oscillations of the head. Such pitching can be caused by micro-waviness of the disk itself, although the cause of the pitching is not central to the invention.

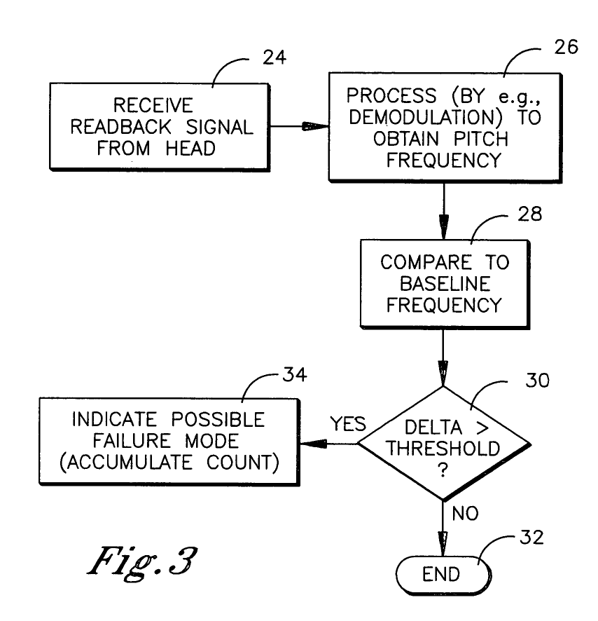

FIG. 3 shows an exemplary form of the present logic in non-limiting flowchart format. The logic preferably may be implemented in the controller 18. It may also be implemented in other processing devices, such as test fixture computers, etc.

Commencing at block 24, the read-back signal from the head 16 is received. While only a single head 16 is shown and discussed herein, it is to be understood that the HDD typically contains several heads and several layers of disks, and that the logic can be executed for each head.

At block 26, the read-back signal is processed to determine the pitch frequency of the head 16. Preferably, the pitch-2 frequency is determined, although the pitch-1 frequency may also be used.

As recognized herein, the pitching of the head modulates the amplitude of the read-back signal to produce two sidebands around the data frequency or the servo synch frequency. Accordingly, in one non-limiting embodiment, the read-back signal is demodulated to obtain the sidebands and, hence, the pitch frequency. Other processing can be used in addition to or in lieu of simple demodulation, e.g., a fast Fourier transform (FFT) can be applied to output the pitch frequency. It is to be understood that the processing in specific embodiments, particularly when undertaken by the channel chip, can include digital amplitude modulation, digital filtering, and digital FFT processing as might be implemented using digital signal processor (DSP)-based demodulation.

With more specificity, two general methods may be used to detect the pitch frequency in the read-back signal. First, the sidebands of any data or servo signal on the disk may be used. Or more preferably, the threshold of the high-pass filter of the arm electronic chip (AE chip) that is provided in HDDs may be reduced, with the P2 frequency directly derived from the FFT of the read-back signal.

If the first method is selected to look only for sidebands, a signal on the disk at a fixed frequency may be written to disk, and sidebands next to that fixed frequency may be sought. Or, the already existing servo sync pattern on the disk can be used and sidebands near the servo sync frequency monitored. As understood herein, the servo sync frequency is product dependent and varies (currently) from 20 MHz to 100 MHz, so that, for instance, if the servo frequency is at 100 MHz, and the P2 frequency is at 300 kHz, the amplitudes at 99.7 MHz and/or 100.3 MHz can be monitored. In this case, a variation from the expected sideband frequencies corresponds to a change in the P2 mode frequency. Because the servo sync frequency is fixed throughout it may not be necessary to perform a FFT. Instead, a sharp notch filter can be applied to the read-back signal at 99.7 MHz and 99.6 MHz. If the amplitude at 99.7 MHz reduces and the amplitude at 99.6 MHz increases, the logic concludes that the P2 mode has increased from 300 kHz to 400 KHz, indicating contamination or lube/asperity contact.

Alternatively to using the servo sync pattern, a single frequency pattern can be written on the disk. Most HDD have already, as part of so-called “SMART” technology, dedicated areas on the disk reserved for failure prediction testing. In these areas, data can be written and read-back. Sidebands or the low frequency components of the FFT of the read-back signal can then be looked at for indications of lube/contamination buildup, as discussed further below.

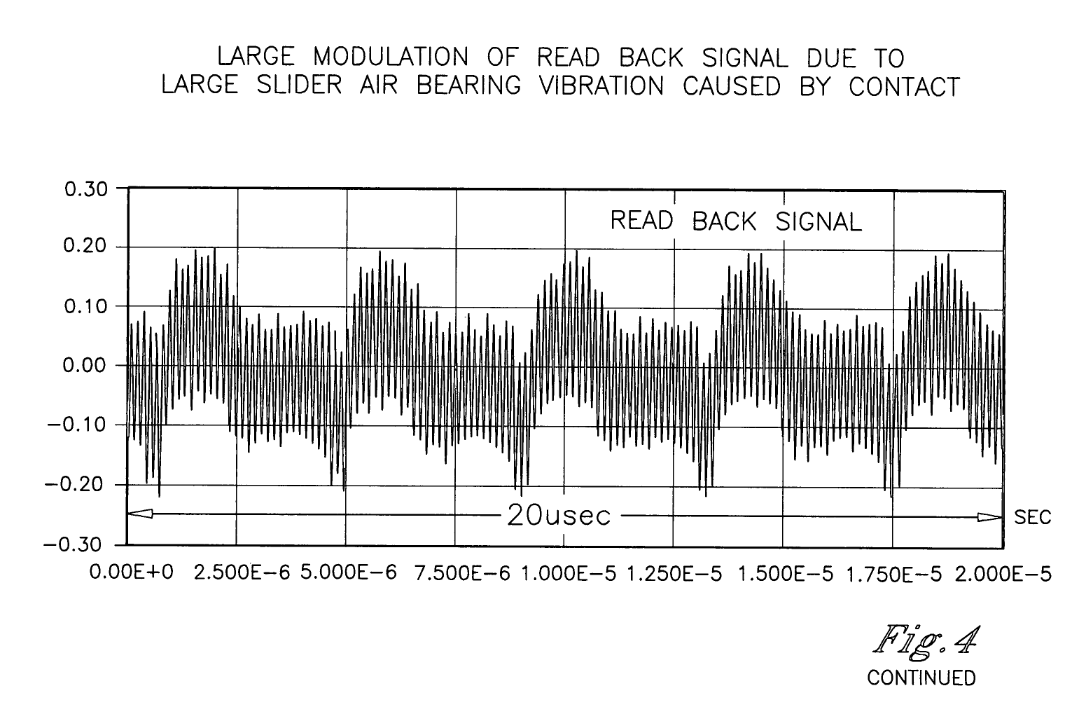

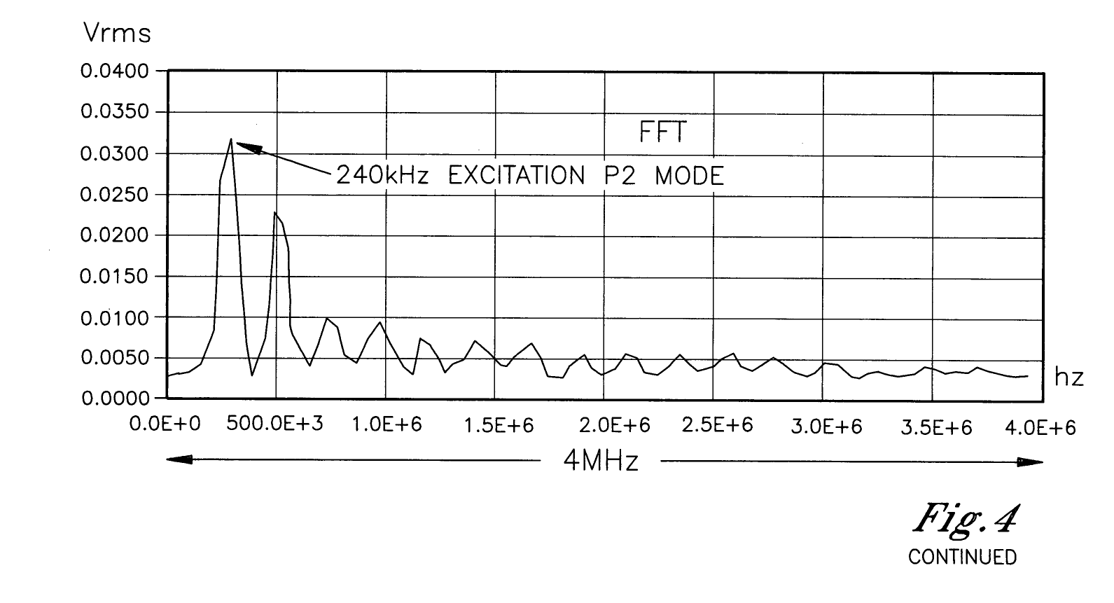

As mentioned above, instead of monitoring sidebands of a data or servo pattern, the low frequency content of the FFT can be monitored to directly observe any shifts of the P2 frequency. In current products, most arm electronic chips perform a high pass filter of the read-back signal at about 1 MHz to 5 MHz. This significantly suppresses or eliminates the P2 mode from the read-back signal. Consequently, by reducing the high pass filter from about 2 MHz to about 200 KHz, either temporarily or permanently, the P2 frequency can be easily detected around 300 kHz. The present invention recognizes that many of the current arm electronic chips have the option to switch the high pass filter between various settings. Hence, for optimum detection of air bearing modes, one could switch the high pass filter to a lower setting and read back any pattern on the disk (data, servo, or fixed frequency) and monitor the FFT in the air bearing frequency range (200 KHz to 600 kHz). This is illustrated in FIG. 4, which shows the P2 mode (240 KHz) and P2 mode harmonics in the FFT of the read-back signal.

To extract the P2 frequency from the read-back signal, either a test signal can be written into a dedicated zone, or prewritten data or the servo sync pattern can be used as the read-back signal. The present invention understands that writing a dedicated zone for failure prediction undesirably is relatively time consuming and requires the allocation of some small amount of disk real estate, but has the advantage of yielding relatively high signal to noise ratios. In contrast, by using the prewritten data or servo signal on the disk as the read-back signal source, real time monitoring of the P2 mode frequency is achieved without the drawbacks noted above but at the cost of a slightly lower signal to noise floor.

In summary, in the indirect method of inferring pitch frequency changes, a single frequency pattern is written at a dedicated SMART zone on the disk (e.g., at the OD, MD, and ID of the disk), and then the sine wave pattern is read back and a FFT is performed on it. Sidebands are monitored that are next to the sine wave frequency peak and that correspond to the air bearing pitch 2 mode. The high pass filter on the arm electronic chip can then be switched from, e.g., 2 MHz to a value of around 200 KHz and the FFT of the read-back signal monitored in the 200 to kHz range, typically 300 kHz, with pitch changes inferred from amplitude changes in the monitored signals.

To sum up the direct method of observing changes in pitch frequency itself, any part of the data pattern on the disk (which advantageously does not require a dedicated zone) arbitrarily may be read back and have a FFT performed on it, with the sidebands of the servo sync pattern monitored to directly detect changes in pitch frequency (and, thus, indication of lube/contaminant buildup). Typically, the servo sync pattern is always at a fixed frequency on the disk of around 50 MHz. Or, sidebands of any data pattern may be used, instead of the data pattern, but this is less desirable since many data frequencies are present. In either case, the high pass filter on the arm electronic chip is switched from, e.g., 2 MHz to a value of less than 200 KHz and the FFT of the read-back signal monitored in the 200 KHz to 600 KHZ range, with the P2 frequency ordinarily detected around 300 KHz.

Regardless of which method is used to obtain pitch frequency, proceeding to block 28, the measured pitch frequency (or, in the case of the indirect method, the measured amplitude) is compared to a baseline value. The baseline value can be predefined to be the expected nominal value, or it can be an initially measured value, or it can be a measured steady state value. In any case, as indicate above when it is determined at decision diamond 30 that the measured value deviates from the baseline by more than a difference “delta” (which may be set to near zero if desired), and usually when it is determined that the pitch frequency has risen above the baseline thus indicating lower than expected flying height induced by lubricants pickup and/or contamination, instead of ending at state 32 the logic can proceed to block 34 to indicate a possible failure mode. In some instances, a decrease in pitch frequency can indicate a failure. A single variance from baseline may be sufficient to trigger indication of possible failure, or, to minimize false alarms, plural sufficiently large deviations within a particular time period may be required prior to indicating an impending failure. The indication can be a signal sent to a host computer indicating that the HDD is or may be about to experience a failure.

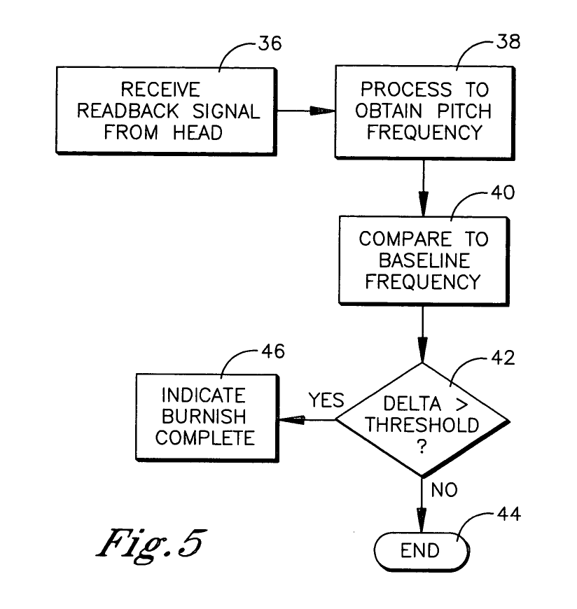

FIG. 5 shows logic for an alternate application, namely, using pitch frequency variations as indicated by a head read-back signal to determine when a head pad has been sufficiently burnished in pad burnish HDDs during manufacture. Commencing at block 36, the read-back signal from the head 16 is received during pad burnish incident to HDD manufacture. At block 38, the read-back signal is processed to determine the pitch frequency of the head 16 in accordance with principles set forth above. Preferably, the pitch-2 frequency is determined, although the pitch-1 frequency may also be used.

Proceeding to block 40, the measured value is compared to a baseline value that can be predefined or an initially measured value produced before the head pad has been fully burnished. In any case, when it is determined at decision diamond 42 that the measured value deviates from the baseline by more than a difference “delta” (which may be set to near zero if desired), instead of ending at state 44 the logic can proceed to block 46 to indicate that, as indicated by the change in pitch frequency, the head has been sufficiently burnished away from the disk and, hence, that burnishing is complete. The indication can be a signal sent to a burnish control computer indicating that the burnishing of the pad is complete.

In addition to using pitch frequency as obtained from the read-back signal for purposes of determining lubricants/contamination build up and completion of pad burnishing, the present invention recognizes that the pitch frequency can have other useful applications as well. For example, using the pitch frequencies of each head (which increase as flying height decreases), the overall flying behavior of each head in a drive can be monitored and compared with each other after the drive is turned on and then perhaps every few hours of operation. It is known that tolerances caused by the assembly process can lead to flying height variations between heads of a few nanometers, which means that the pitch frequency of each slider in a drive can vary by 5 KHz to 20 KHz or even more. Accordingly, if a drive contains ten sliders and it is determined, using the pitch frequencies of the sliders as described above, that all bottom flying sliders have a high pitch 2 frequency compared to the top flying sliders (top of the disk), then poor assembly might be indicated. Or, drive mishandling leading to an offset of the spindle chuck might be indicated if a pitch frequency shift for only certain sliders in the HDD is sensed. Still further, in accordance with these principles, from the variations in pitch 2 frequency the efficacy of manufacturing sigmas can also be better understood.

While the particular SYSTEM AND METHOD FOR GENERATING DISK FAILURE WARNING USING READ BACK SIGNAL as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconciliable with the present specification and file history.

1. A controller in a hard disk drive (HDD) and executing logic, the logic comprising:
receiving a read-back signal from at least one head in the HDD;
deriving from the read-back signal at least one signal representative of a pitch frequency of the head; and
based at least in part on the signal representative of a pitch frequency, determining at least one of: whether to generate a warning of a failure mode, and whether to indicate completion of pad burnishing.

2. The controller of claim 1, wherein the read-back signal is demodulated to determine the pitch frequency.

3. The controller of claim 1, wherein the pitch frequency is the Pitch-2 mode frequency.

4. The controller of claim 1, wherein the warning is generated by sending a signal to a host computer that the HDD may experience a failure.

5. The controller of claim 1, wherein the pitch frequency is compared to a threshold frequency to determine whether to generate a warning of a failure mode.

6. The controller of claim 1, wherein plural measured pitch frequencies are compared to a threshold frequency prior to determining whether to generate a warning of a failure mode.

7. The controller of claim 1, wherein a pitch frequency change is inferred from an amplitude change of at least one sideband signal.

8. A hard disk drive (HDD) executing a method comprising:
deriving a signal representative of a slider pitch frequency using a read-back signal from a head associated with the slider; and
based at least in part on the signal, indicating at least one of: whether a disk failure is imminent, and whether a pad has been sufficiently burnished during manufacture.

9. The HDD of claim 8, wherein the read-back signal is demodulated to determine the pitch frequency.

10. The HDD of claim 8, wherein the pitch frequency is the Pitch-2 mode frequency.

11. The HDD of claim 8, wherein a warning is generated by sending a signal to a host computer that the HDD may experience a failure.

12. The HDD of claim 8, wherein the pitch frequency is compared to a threshold frequency to determine whether to generate a warning of a failure mode.

13. The HDD of claim 8, wherein a pitch frequency change is inferred from an amplitude change of at least one sideband signal.

14. A chip for a hard disk drive (HDD), comprising:
means for receiving a read-back signal from a head of the HDD;
means for deriving a pitch frequency from the read-back signal; and
means for comparing the pitch frequency to a value to determine whether to indicate a possible failure is impending, and/or to determine whether to indicate that a pad has been sufficiently burnished.

15. The chip of claim 14, wherein the means for deriving demodulates the read-back signal to determine the pitch frequency.

16. The chip of claim 14, wherein the pitch frequency is the Pitch-2 mode frequency.

17. The chip of claim 14, wherein the HDD generates a warning by sending a signal to a host computer that the HDD may experience a failure.

18. The chip of claim 14, wherein the means for comparing compares the pitch frequency a threshold frequency to determine whether to generate a warning of a failure mode.

19. The chip of claim 14, wherein the means for comparing compares plural measured pitch frequencies to at least one threshold frequency prior to determining whether to generate a warning of a failure mode.
